(19) United States
(12) Patent Application Publication
(10) Pub. No.: US 2005/0129261 A1
(43) Pub. Date: Jun. 16, 2005

(54) Electronic instrument

(76) Inventors: Fumihisa Ito, Gunma (JP); Yoshiyuki Watanabe, Gunma (JP); Norikazu Sashida, Gunma (JP); Shigeo Ishii, Gunma (JP); Naoki Maki, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/956,576

(22) Filed: Oct. 1, 2004

(30) Foreign Application Priority Data
Oct. 3, 2003 (JP) 2003-346437

(51) Int. Cl. H04R 25/00

(52) U.S. Cl. 381/190

(57) ABSTRACT

It is designed to restrain vibration of a casing, efficiently drive a piezoelectric sounding body (such as a piezoelectric speaker) and flatten sound pressure characteristic within the electronic instrument requiring the miniaturized type, light weight, and thin type in the electronic instrument, in particular the portable telephone. For accomplishing these objects, at a back side of a mass part within the casing of the electronic instrument, the piezoelectric sounding body is mounted via a ring shaped cushioning material. At a part not overlapping with the mass part, a partition is provided. A main air-chamber is tightly formed by the mass part, the piezoelectric sounding body, and the partition, and in the casing within the main air-chamber, a sound issuing hole is formed. The sound outputted from the upper face into the main air-chamber is outputted outside of the casing from the sound issuing hole. Vibration generated from the piezoelectric sounding body interferes with the mass part, so that transmission of vibration to the casing is restrained, and since the space of the inside and outside of the piezoelectric sounding body is served as the air-chamber, the sound pressure characteristic is made flat.

### FIELD OF THE INVENTION

The present invention relates to piezoelectric sounding bodies (such as piezoelectric type speakers) functioning as acoustically transducing electronic parts of buzzers or speakers, and relates to an improvement of electronic instruments such as portable telephones utilizing such piezoelectric speakers.

### BACKGROUND OF THE INVENTION

Acoustically transducing electronic parts used in portable telephones include a dynamic type making use of electromagnetic induction, and a piezoelectric type making use of piezoelectric phenomena. In the acoustically transducing electronic part of the dynamic type, as one embodiment shown in FIG. 11A, a circular diaphragm 900 formed with a resin such as PET (polyethyleneterephthalate) is supported by a cylindrical coil 902 whose back side is a driving source and that inside is arranged with a magnet 904. The magnet 904 is respectively furnished on opposite sides with yokes 906, 908 so as to form a magnetic path. The coil 902 is transverse with the magnetic path held between the yokes 906, 908. The outside yoke 908 is supported in, for example, a metal case 910, and the diaphragm 900 is put on a surface with a cover 914 having sound issuing holes 912, with the cover 914 being secured to the case 910. When the coil 902 is supplied with sound signals, the coil 902 vibrates vertically in response to the signals, this vibration is transmitted to the diaphragm 900, so that an air-vibration occurs to output sounds from the sound issuing holes 912.

The acoustically transducing electronic part of the piezoelectric type has, as one embodiment shown in FIG. 11B, a diaphragm 920 with a piezoelectric element 922 attached on one side and supported on the circumference of the diaphragm 920 by a ring-shaped case 924. The shown embodiment is an example of a bimorph type where the piezoelectric elements 922 are attached to the front and back sides of the diaphragm 920. The case 924 is provided with a cover (not shown), if needed.

When the piezoelectric element 922 is supplied with a sound signal, the piezoelectric element 922 expands and contracts in a radial direction, and the diaphragm 920 bends, so that the air-vibration occurs to generate sounds. Since phases of the air-vibration occurring on the front and back sides of the diaphragm 920 are different by 180 degrees, either one of the front or back sides of the diaphragm 920 is sealed with the case 924 and the cover so as to form an acoustic space.

These acoustically transducing electronic parts are mounted within the casing of an electronic instrument. For example, such a structure is employed which attaches the acoustically transducing electronic parts on the inside of the casing of the portable telephone to issue sounds from holes formed in the casing. FIG. 11C shows one embodiment of mounting the piezoelectric sounding body 926 shown in FIG. 11B installed in the inside of the casing 930. Then an appropriate cushioning material 932 is interposed between the case 924 of the piezoelectric sounding body 926 and the casing 930, and those are adhered closely. The casing 930 is formed with the sound issuing hole(s) 934 from which the sounds are outputted outside. It is also possible to use a waveguide pipe and dispose the piezoelectric sounding body at a position separate from the sound issuing hole.

By the way, since the acoustically transducing electronic parts of the above mentioned dynamic type are complicated in structure and have a large number of parts including coils 902, a certain thickness must be secured. Further, in a case of a narrow space, those parts are influenced by air viscosity, and therefore a certain capacity of the casing is necessary. But since the diaphragm 900 is driven by vertical movement of the coil 902 within magnetic flux, the diameter of the diaphragm 900 can be reduced. Vibrational energy owned by the diaphragm itself is small, and is not significantly influenced by vibration of the case 910 and the characteristics of the parts.

On the other hand, the acoustically transducing electronic parts of the piezoelectric type are simple in structure, less in number, and possible to be lightened. But since a stretching movement of the piezoelectric element 922 is converted into concave/convex curving movement of the diaphragm 920, amplitude depends on the diameter of the diaphragm 920. Accordingly, for increased sound pressure, the diameter of the diaphragm must be enlarged. In addition, the acoustically transducing electronic part of the piezoelectric type easily becomes irregular in frequency characteristics due to resonance phenomena, and is difficult to produce flat frequency characteristics. When mounted to a portable telephone, since the vibrational energy owned by the piezoelectric sounding body itself is large and conformity of mechanical impedance with the case is good, the vibration easily transmits to the case 924 when mounted, and proper vibration different from the vibration produced inherently by the piezoelectric sounding body occurs by the vibration of the case 924.

### SUMMARY OF THE INVENTION

The above and other features and advantages of the present invention will become apparent from the following detailed description taken with the accompanying drawings.

### BRIEF DESCRIPTION OF THE DRAWINGS

FIG. 1 is views showing a structure of an embodiment 1 of the invention;

FIG. 2 is a graph showing a characteristic of the sound pressure frequency of the embodiment 1;

FIG. 3 is a view showing the relationship between the structures and the characteristics in a plurality of samples using the piezoelectric sounding body;

FIG. 4 is a view showing the relationship between the structures and the characteristics in a plurality of the samples using an acoustic transducer of the dynamic type;

FIG. 5 is views of the cross sections and the plans of the samples when changing the contacting areas between the piezoelectric sounding body and the mass parts;

FIG. 6 is the graph showing the sound pressure frequency characteristics when changing the contacting areas between the piezoelectric sounding body and the mass part;

FIG. 7 is the graph showing the relationship between an air-chamber and the area of the piezoelectric sounding body;

FIG. 8 is a major cross sectional view showing the structure of the embodiment 2 of the invention;

FIG. 9 is major views showing the structures of the embodiment 3 of the invention;

FIG. 10 is the major views showing the structures of the embodiment 3 of the invention; and

FIG. 11 is the views showing the structures of the piezoelectric sounding body and the attaching structures in the conventional electronic instruments.

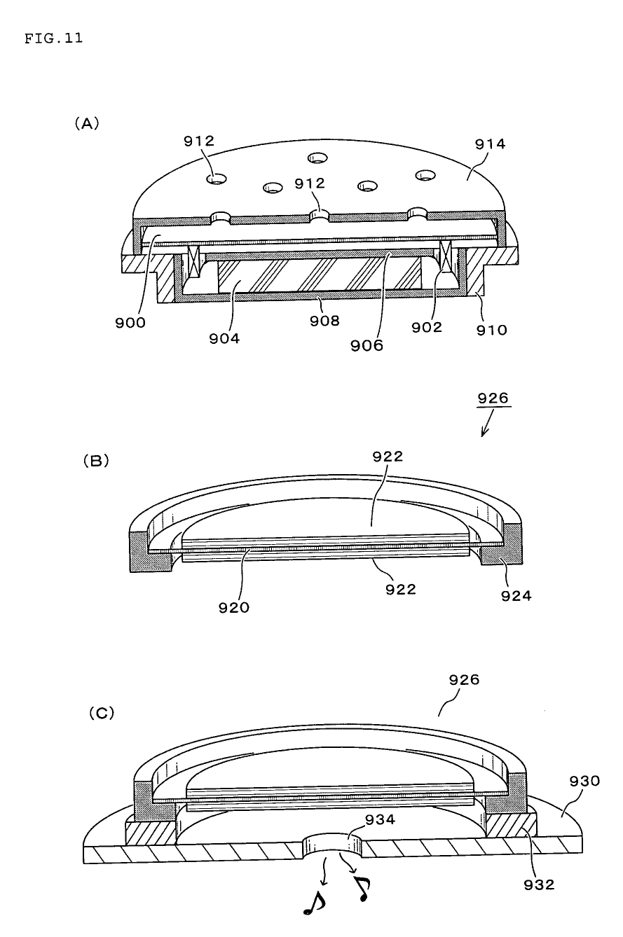

### DETAILED DESCRIPTION AND MOST PREFERRED EMBODIMENTS

The present invention is susceptible of numerous physical embodiments, depending upon the environment and requirements of use, substantial numbers of the herein shown and described embodiments have been made, tested and used, and all have performed in an eminently satisfactory manner.

### (1) Embodiment 1

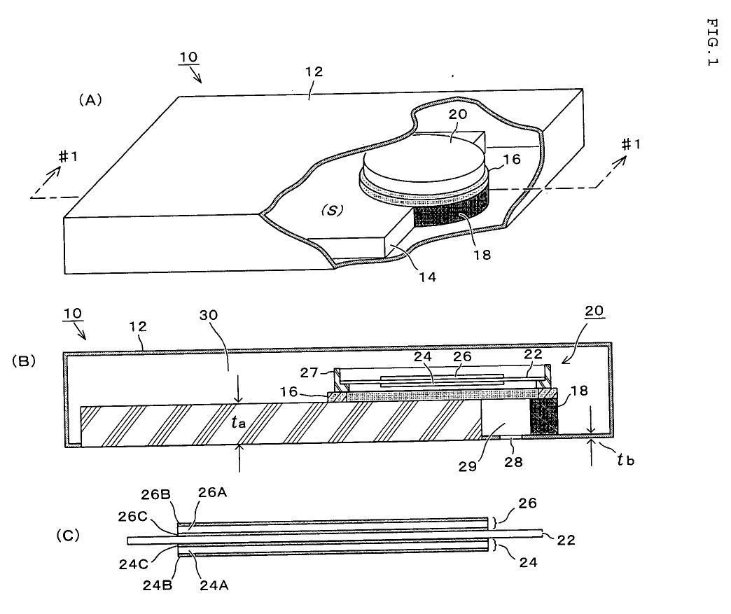

At first, referring to FIGS. 1 to 7, the embodiment 1 of the invention will be explained. FIG. 1A shows the whole structure of the embodiment 1, and a cross section seen in a direction of arrows along #1-#1 of FIG. 1A is shown in FIG. 1B. Enlarged vibrating parts of FIG. 1B are shown in FIG. 1C.

In these views, as to the electronic instrument 10, various electronic parts are housed in the casing 12, and a mass part (mass body) 14 among the parts is shown. The mass part 14 may, for example, comprise such parts having comparatively large mass, for example, a liquid crystal display of the portable telephone or a battery box holding a charging battery. It may be an assembly of several parts. The piezoelectric sounding body 20 is mounted at a back side of the mass part 14 (the inside of the casing 12 of the mass part 14) via a ring shaped cushioning material or a spacer 16. Specifically, the piezoelectric sounding body 20 may be closely adhered to the mass part 14 with the cushioning material 16 of thickness being 0.4 mm and an inner diameter being 20 mm provided with adhesive layers on both main faces. As shown FIG. 1B, the piezoelectric sounding body 20 may only partially overlap the mass part 14, and a part not overlapping with the mass part 14 is provided with a partition 18 of 2.5 mm in height. The thickness of the cushioning material 16 is preferably 0.1 to 1.0 mm, and the height of the partition 18 is set by deducting the thickness of the wall of the casing 12 from the thickness of the mass part 15, preferably 1.0 to 5.0 mm.

As shown in FIG. 1C, the piezoelectric elements 24, 26 are attached on the front and back sides of the circular diaphragm 22 formed with a metallic material such as a phosphor bronze or 42-alloy, or a resin material such as polyethylene-terephthalate (PET). In one embodiment, the diameter of the diaphragm made of the phosphor bronze is 23 mm and the thickness is 30 μm. The piezoelectric element 24 is structured in that electrodes 24B, 24C such as of Ni, Pd, or Ag are formed on the front and back sides of the piezoelectric sheet 24A of the piezoelectric ceramics such as lead titanate zirconate (PZT). The piezoelectric element 26 is similarly structured in that the electrodes 26B, 26C are formed on the front and back sides of the piezoelectric sheet 26A of the piezoelectric ceramics such as PZT. The diaphragm 22 may serve as the electrodes 24C, 26C. The diaphragm 22 is secured by a silicone-type adhesive at its circumference in the center in height of a ring-shaped case 27 of the 0.7 mm height having an inner shoulder. For the case 27, a metallic material such as a stainless steel, or a resin material such as polyethyleneterephthalate (PET) or acrylonitrile butadiene styrene (ABS) may be used. The illustrated embodiment is a bimorph type, and there is also a unimorph type having only one of the piezoelectric elements 24, 26.

Basic movements of such a structured piezoelectric sounding body 20 are similar to those of the above mentioned conventional techniques. When the piezoelectric elements 24, 26 are applied with sound signals, one of the piezoelectric elements 24, 25 extends in the radial direction and the other shrinks in the same direction, so that the diaphragm 22 is bent to vibrate the air and issue the sound.

Returning to FIGS. 1A and B, a main air-chamber 29 is air tightly-formed with the above mentioned mass part 14, piezoelectric sounding body 20, and partition 18, and a sound issuing hole 28 is formed in the casing 12 within the main air-chamber 29. Specifically, the capacity of the space defined at the inside of the inner diameter of the ring shaped cushioning material 16 is 126 mm³, the capacity of interior space surrounded by the partition 18 and the mass part 14 is 192 mm³, and the capacity of the main air-chamber at this time is 318 mm³. As mentioned above, the sound is issued by bending of the diaphragm 22, and the issued sound is outputted in the direction of the front and back sides (up and down in FIG. 1B) of the piezoelectric sounding body 20. The sounds outputted into the main air-chamber 29 from the outside (the side of the piezoelectric element 24) are outputted outside of the casing 12 from the sound issuing hole 28. The sounds outputted into a sub air-chamber 30 inside of the casing 12 from the backside (the side of the piezoelectric element 26) of the piezoelectric sounding body 20 remain within the casing 12. This prevents the mixing of both of the sounds since the phases of the air vibration occurring at the inside and outside of the diaphragm 22 are different 180 degrees. Electronic components or other parts may be present in the main air-chamber 29 or the sub air-chamber 30.

In this embodiment, the piezoelectric sounding body 20 is mounted at the back edge of the mass part 14 within the casing 12 of the electronic instrument 10. Therefore, in comparison with the prior art of mounting the piezoelectric sounding body 20 in the casing 12 (which is thinner than the mass part 14), vibration generated from the piezoelectric sounding body 20 interferes with the mass part 14, so that transmission of vibration to the casing 12 is restrained, and since the space between the front and back sides of the piezoelectric sounding body 20 is served as the air-chamber, the sound pressure characteristic is made flat. In the present invention, the thickness of the casing 12 is meant the thickness (t_{b}) of the wall of the casing, while the thickness of the mass part 14 is meant the total thickness (tₐ) of the material under the sounding body 20. The piezoelectric speaker is meant the sounding body which uses the piezoelectric element. Embodiments of the invention have a wide frequency band and flat frequency-sound pressure characteristic in the frequency band of 1 to 3 KHz, and is used in a free sound field.

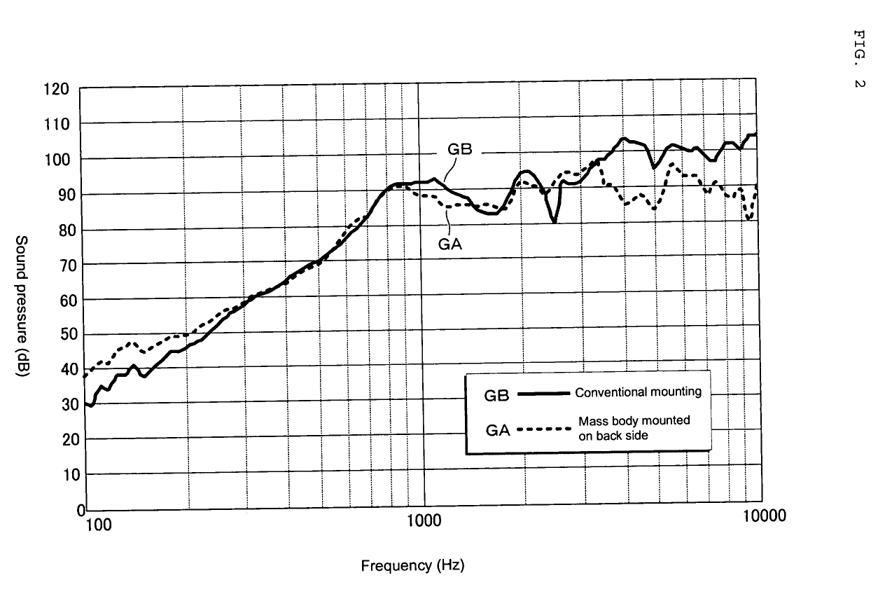

FIG. 2 shows a measured sound pressure frequency characteristics. In FIG. 2, the graph GA is the characteristic of the present embodiment, and the graph GB is the characteristic of the above mentioned prior art. A vertical axis is the sound pressure (dB), and a lateral axis is the frequency (Hz). As is apparent by comparing graphs GA and GB, the graph GA shows better flatness in the frequency range from 1 to 10 kHz. The graph GA shows that the sound pressure varies in the range of 80 to 98 dB, while the graph GB shows that the sound pressure varies in the range of 80 to 105 dB, and irregularities of the characteristics are large.

If the resonance frequency of vibration associated with the mass part 14 is out of the audio-frequency range (ordinarily, around 300 to 4000 Hz), influences to the sound by the vibration of the mass part 14 is reduced. Assuming that the mass of the mass part 14 is Mₐ, the area (the whole area of the face with which the piezoelectric sounding body 20 overlaps) is S, and the thickness is tₐ, the resonance frequency fₒ owned by the mass part 14 is expressed with
fₒα√(S/ma)=√((tₐ²·E)/(S²·ρ))=(tₐ/S)·√(E/ρ) (1)
Herein, E is the Young's modulus of the mass part 14, ρ is the density of the mass part 14, Mₐ=S·tₐ·ρ. “√(S/ma)” expresses “(S/ma)^{1/2}”. To make the resonance frequency fₒ larger than the audio-frequency range, it is sufficient to make the thickness tₐ of the mass part 14 large or make the area S small.

Furthermore, if the frequency of the sound outputted from the piezoelectric sounding body 20 is low, since the vibrating amplitude of the mass part 14 is in inverse proportion to its stiffness S_{f}, the amplitude is
Amplitudeα1/S_{f}=S/(tₐ³·E) (2)
When the frequency of the sound is high, since the vibrating amplitude of the mass part 14 is in inverse proportion to its mass Mₐ,
Amplitudeα1/Mₐ=1/(S·tₐ·ρ) (3)
Accordingly, in either case, by making the thickness tₐ of the mass part 14 large, which will mean the mass Mₐ of the mass part will also be large, it is possible to restrain the amplitude. By the way, from the above mentioned formula (2),
S_{f}=(tₐ³·E)/S (4)

Taking the above mentioned points into consideration, the following conclusions can be made:

1) Desirably, the thickness tₐ of the mass part 14 is large, but it is good that the thickness t_{b} of the casing 12 is small (on a premise of having a desired strength) from the viewpoint of making the electronic instrument 10 light in weight. Accordingly, the relation between the thickness tₐ of the mass part 14 and the thickness t_{b} of the casing 12 is desirably tₐ>t_{b}. For example, assuming that a lithium ion (Li-Ion) battery is the mass part 14 and a casing of the portable telephone is the casing 12, if the thickness tₐ of the lithium ion battery is 6 mm and the thickness t_{b} of the wall of the casing 12 is 1 mm, it is possible to obtain a good sound pressure characteristic while restraining the vibration of the casing 12 by mounting the piezoelectric sounding body 20 on the lithium ion battery.

2) It is good that the mass Mₐ of the mass part 14 is large, but it is good that the mass M_{c} of the piezoelectric sounding body 20 is small from the viewpoint of making the electronic instrument 10 light in weight. Accordingly, the mass Mₐ of the mass part 14 and the mass M_{c} of the piezoelectric sounding body 20 is desirably Mₐ>M_{c}. For example, assuming that the piezoelectric sounding body mounted on the portable telephone is 0.6 g and the lithium ion battery is 18 g, it is possible to obtain a good sound pressure characteristic while restraining the vibration of the casing 12 by mounting the piezoelectric sounding body 20 on the lithium ion battery.

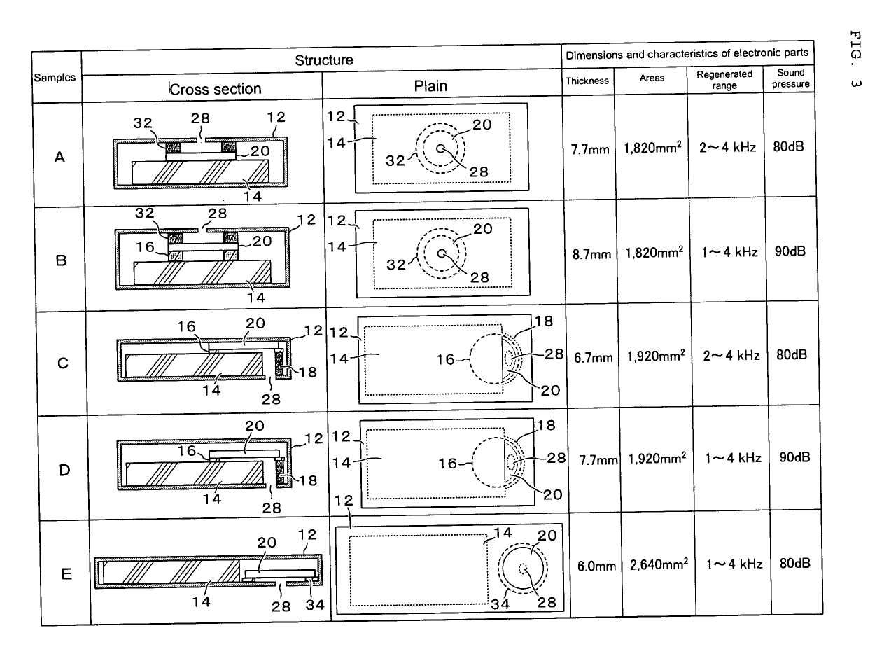

Next, referring to FIG. 3, as to the samples made by way of trial, the characteristics will be compared. In FIG. 3, the sample A is an example of directly attaching the piezoelectric sounding body 20 on the mass part 14, in which the cushioning materials 32 are held between the piezoelectric sounding body 20 and the casing 12 of the electronic instrument. The sample B is an example of attaching the cushioning materials 16 between the piezoelectric sounding body 20 of the sample A and the mass part 14. The sample C is an example of arranging the piezoelectric sounding body 20 and the mass part 14 such that they partially overlap, and at the same time the backside of the piezoelectric sounding body 20 contacts the casing 12. The sample D is the present embodiment. The sample E is an example of attaching the piezoelectric sounding body 20 to the casing 12 via the cushioning materials 34, and corresponds to the above mentioned prior art.

Measuring the scales and the characteristics of the electronic instruments of these samples A to E, the results shown in FIG. 3 have been obtained. At first, comparing from the viewpoint of the thicknesses and the areas, in the samples A, B, the thicknesses are fairly large. The samples A, B do not meet the requirements of making the recent electronic instrument thin such as the portable telephone while maintaining good audio characteristics. On the other hand, in the sample E, although the thickness is small, the area is large, and the vibration restraining effect of the invention cannot be brought about. Thus, from the viewpoints of the thickness and the area, the sample C or D is suitable. Comparing from the viewpoints of regenerative frequency zones and the sound pressure, in the samples B and D, the regenerative zones are wide as 1 to 4 kHz, and the sound pressure is high as 90 dB. Therefore, putting the above points together, it is seen that the structure as the sample D of the present embodiment is good, because of the smallest and thinnest type and the good characteristics, where (in the sample D) the piezoelectric sounding body 20 is disposed as overlapping with the mass part 14, and the sound is outputted in the direction of the mass part 14. In the sample D, since the mass part has the back area to a certain extent, this is useful to the piezoelectric acoustically transducing electronic part necessitating the diameter of the diaphragm of the piezoelectric sounding body.

In these mounting methods, the capacity of the casing for mounting the piezoelectric acoustically transducing electronic parts is made narrow so as to increase viscous resistance of the air, so that resonance can be restrained, and the methods can contribute to making the electronic instrument thin.

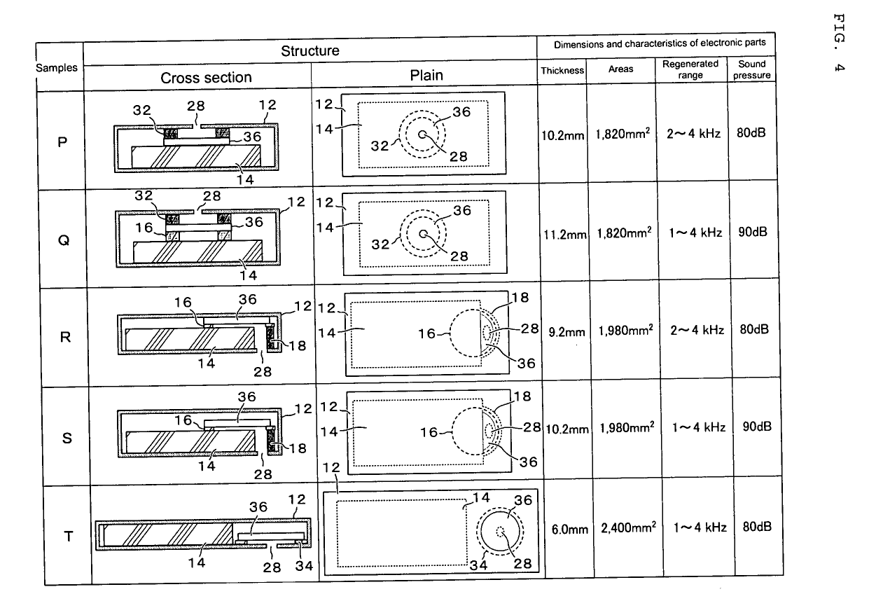

Next, for reference, comparing the same characteristics as to the samples P to T attaching the acoustic transducer 36 of the dynamic type instead of the piezoelectric sounding body 20, the results are as in FIG. 4. The results of FIG. 4 are compared with those of FIG. 3. Although the regenerative frequency zone and the sound pressure are almost the same, the thicknesses of the dynamic type of FIG. 4 is generally larger. This is because the thickness of the acoustic transducer itself of the dynamic type reaches, for example, around 3.2 mm. Even if the acoustic transducer 36 is mounted on the mass part 14 as the sample S, the thickness of the casing 12 is quite large. Also the structure of the sample T requires a very large area.

Comparing merits and demerits in case of using the piezoelectric sounding body and using the acoustic transducer of the dynamic type, the results are as in Table 1.

TABLE 1

| | Mass Parts Present | | | | Mass Parts Absent | | | |
|---|---|---|---|---|---|---|---|---|
| | Characteristics | | Capacity | | Characteristics | | Capacity | |
| | of sound | Vibration | of | Area of | of sound | Vibration | of | Area of |
| Systems | pressure | of casing | casing | casing | pressure | of casing | casing | casing |
| Dynamic | No influences | No | Large | Necessary | No influences | No | Large | Necessary |
| type | | influences | | | | influences | | |
| Piezoelectric | No influences | No | Small | No | Irregularities | Influences | Small | Large |
| type | | influences | | influences | | | | |

As shown in Table 1, when mounting the piezoelectric sounding body on the mass part of the casing, it is possible to produce a small-sized and thin electronic instrument with excellent sound pressure characteristics as compared to the acoustic transducer of the dynamic type.

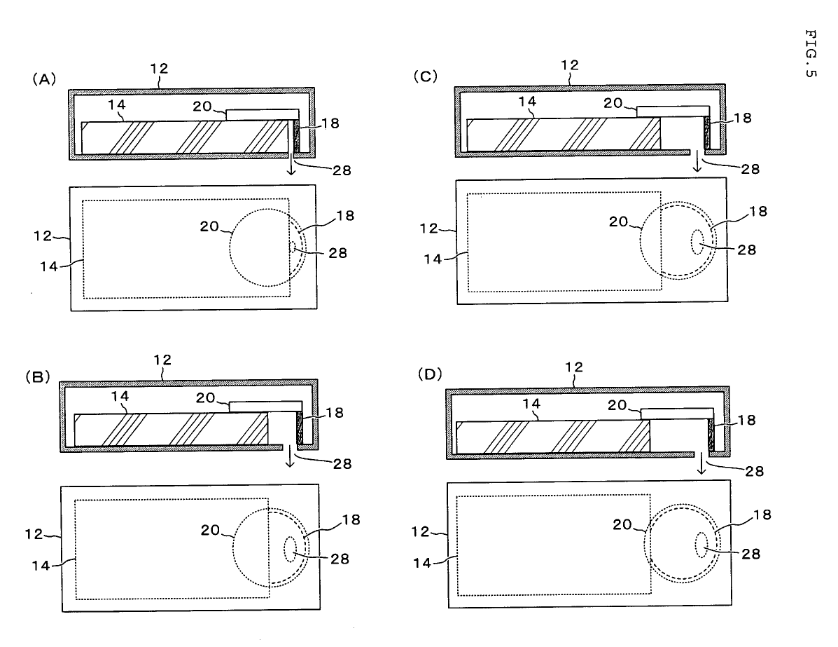

A next consideration will be made to the overlapping condition of the piezoelectric sounding body 20 and the mass part 14, that is, the proportion of the contacting area between the piezoelectric sounding body 20 and the mass part 14 (directly or via the cushioning material). FIGS. 5A to 5D respectively show the conditions in cross section and plan when changing the proportion of the contacting areas. In FIG. 5A, the proportion of the area of contact between the piezoelectric sounding body 20 and the mass part 14 is 98%, almost overlapping. The area of contact in FIG. 5B is 50%, that of FIG. 5C is 30%, and that of FIG. 5D is 10%. Each of the figures shows no cushioning material, although such material may be utilized as shown in FIG. 1.

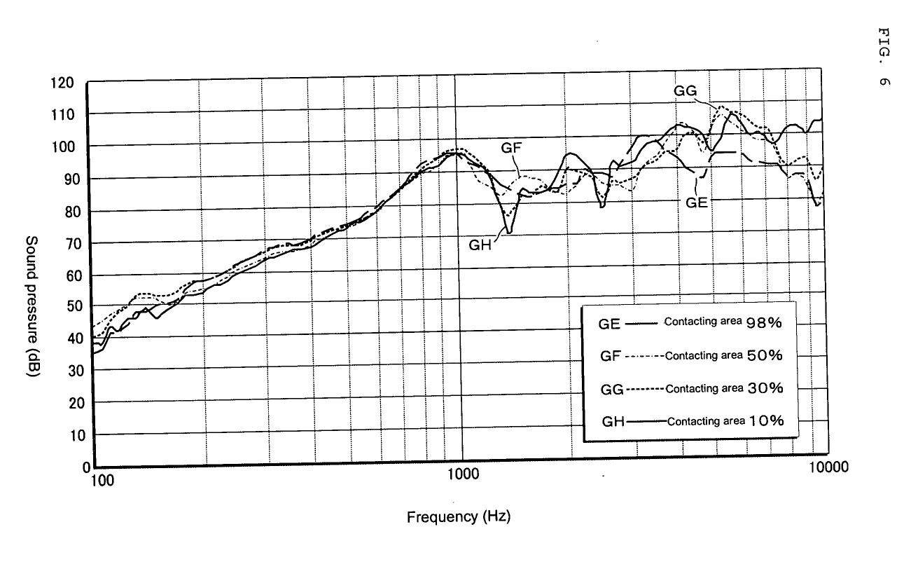

Measuring the sound pressure frequency characteristics as to the samples of the respective embodiments, the results are as shown in FIG. 6. The vertical axis of FIG. 6 is the sound pressure (dB), and the lateral axis is the frequency (Hz). The graphs GE to GH correspond to the rates of 98%, 50%, 30%, and 10% of the above mentioned contacting areas. As shown in the graphs of FIG. 6, the graph GE being 98% of the area of contact and the graph GF being 50% of the area of contact show the good flatness. The graph GG being 30% of the area of contact certainly shows the flattening effect of the sound pressure characteristic, but irregularities are more prominent than those of the graphs GE or GF. Further, the graph GH in which the area of contact is 10% is similar to the graph GB of the prior art scarcely shows the flattening effect. Considering these measuring results, when the rate of the area of contact between the piezoelectric sounding body 20 and the mass part 14 based on the whole contacting area between the part of the piezoelectric sounding body 20 attaching directly or via the cushioning material is 30% or more, the flattening effect of the sound pressure characteristic is recognized, and when it is more than 50%, good flattening characteristic are available.

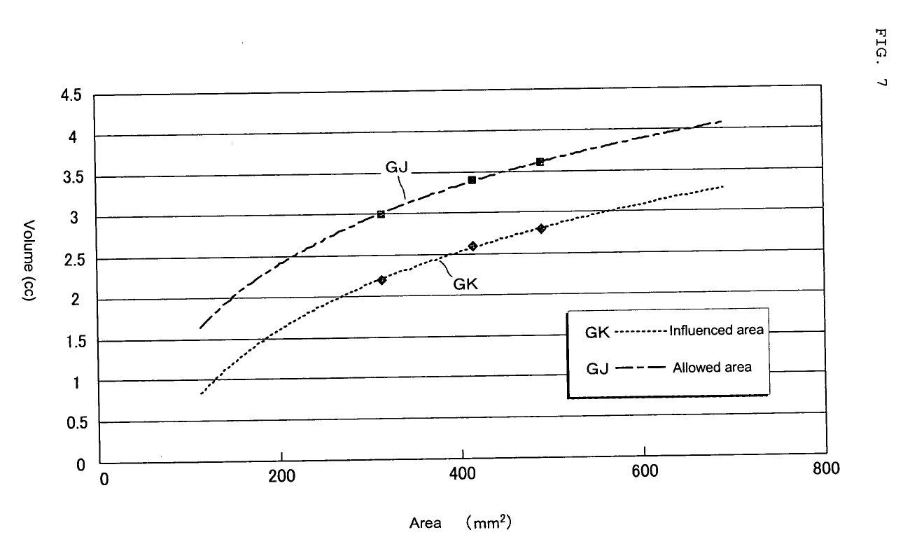

Referring to FIG. 7, the relation between the area of the piezoelectric sounding body 20 and the capacity (volume) of the sub air-chamber 30 is considered. When the capacity of the back of the piezoelectric sounding body 20, that is, the capacity of the sub air-chamber 30 is constant or less, the air in the air chamber becomes viscosity resistant, giving influences to vibration of the diaphragm 22 so that the vibration is restrained. The degree of influence is different in dependence on the size (area) of the diaphragm 22, and the larger is the area, the easier to receive the influences of the capacity of the air chamber (the limited capacity is large). FIG. 7 shows the relation between the area of the diaphragm 22 of the piezoelectric sounding body 20 and the capacity of the sub air-chamber 30. The graph GJ shows changing of the influenced area (the capacity where the sound pressure characteristic decreases under 3 dB), while the graph GK shows the allowed area (the capacity where changing of the sound pressure characteristic is under 1 dB). As shown in these graphs, the larger the area of the diaphragm 22 is, the more the influenced area and the allowed area increase. Therefore, the scale of the capacity of the sub air-chamber 30 may be determined from this information. Incidentally, since the piezoelectric sounding body 20 can be adjusted in the characteristics by the sound issuing hole 28 at the front face, the sound pressure characteristics are the same even if the capacity of the sub air-chamber 30 is infinite, as far as being more than the allowed capacity,.

### (2) Embodiment 2

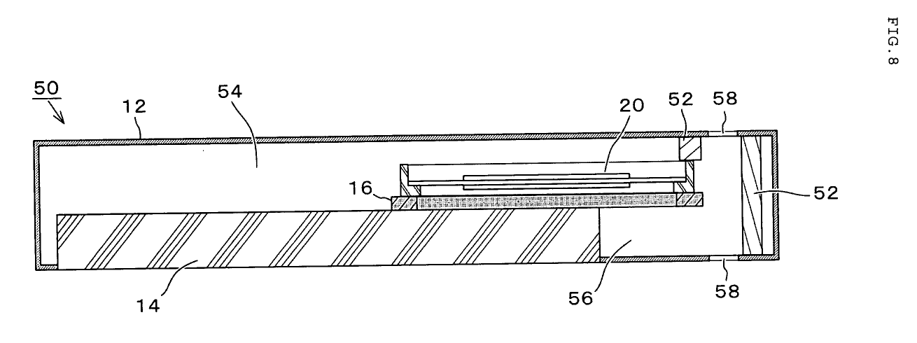

In reference to FIG. 8, the embodiment 2 of the invention will be explained. The electronic instrument 50 of this embodiment is similar to the embodiment 1 in that the piezoelectric sounding body 20 is positioned on the back of the mass part 14 and mounted, but different in that the sound issuing hole 58 is formed on the front and back sides of the casing 12. In this embodiment, at the backside of the piezoelectric sounding body 20, a curved partition 52 is provided between the piezoelectric sounding body 20 and the casing 12, and the interior space of this partition 52 continues to the surface of the piezoelectric sounding body 20. Further, at the other end of the piezoelectric sounding body, a sub air-chamber 54 is defined, and the sub air-chamber 54 and the main air-chamber 56 are divided by the partition 52. The main air-chamber 56 communicates with the front and back sides of the casing 12, each provided with the respective sound issuing holes 58.

If the respective sound issuing holes 58 are provided in the front and back sides of the piezoelectric sounding body 20 for issuing the sound, since the sounds from the surface and from the rear side are at anti-phase, a canceling effect occurs, and the sound pressure goes down. But, the present embodiment can make the most of the area and the thickness of the mounted casing 12 as the above mentioned embodiment, and the sounds of the inside and outside of the casing 12 are at equi-phase, and the sound pressure is not reduced due to the anti-phase.

### (3) Embodiment 3

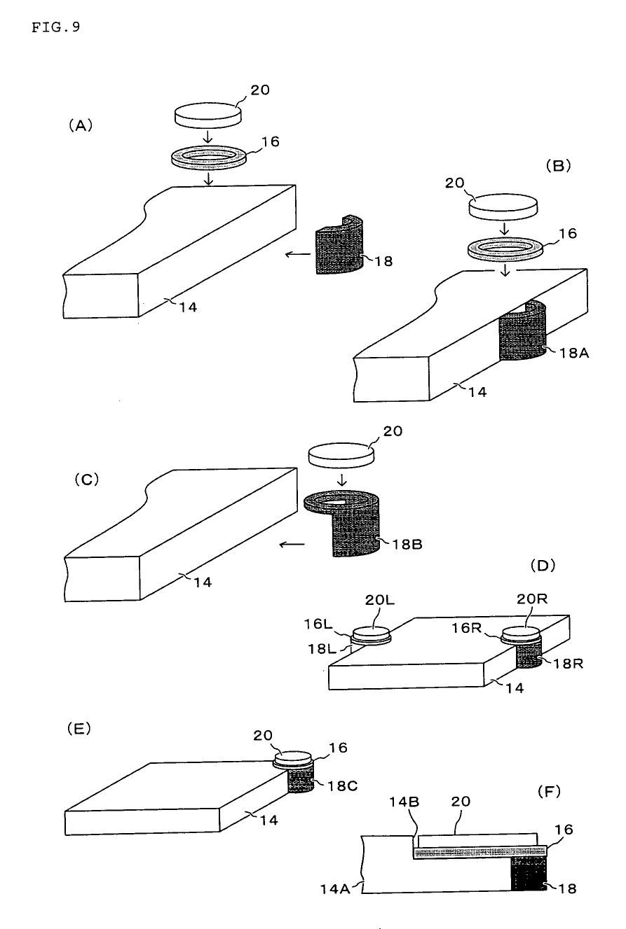

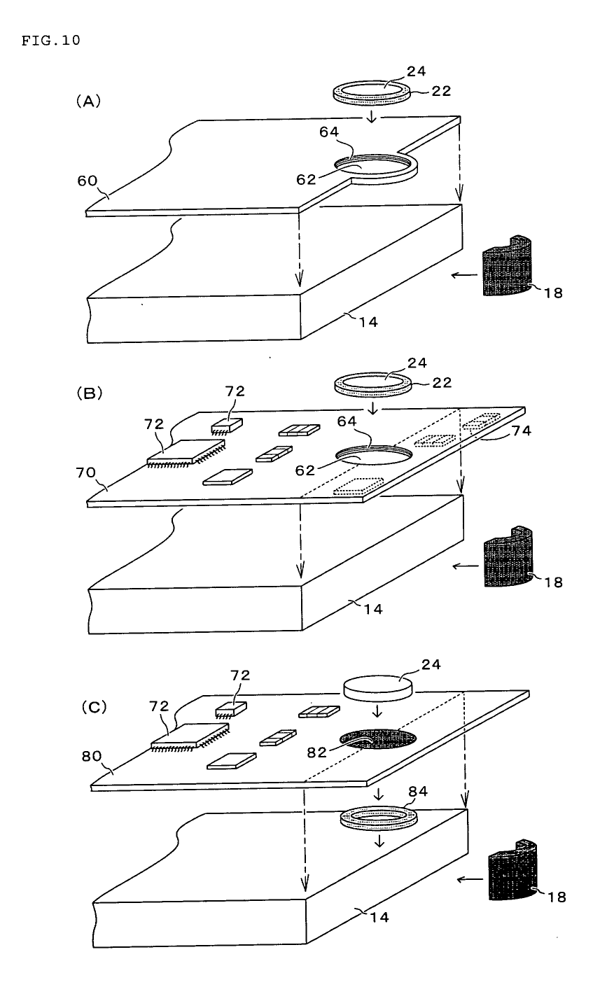

In reference to FIGS. 9 and 10, an embodiment 3 of the invention will be explained. The embodiment shown in FIG. 9A is in some ways similar to the above mentioned embodiment 1, comprising the piezoelectric sounding body 20, the cushioning material 16 and partition 18. The example shown in FIG. 9B unifies the partition 18A and the mass part 14 as one body. The example shown in FIG. 9C unifies the cushioning material and the partition 18B as one body. FIG. 9D installs the piezoelectric sounding bodies 20L, 20R at left and right ends of the mass part 14 respectively via the cushioning materials 16L, 16R and the partitions 18L, 18R, for example, so as to reproduce the sounds of 2 channels such as a stereo. The example shown in FIG. 9E installs the piezoelectric sounding body 20 at the corner of the mass part 14 via the cushioning material 16 and the partition 18C. The example shown in FIG. 9F provides in advance a cutout 14B for the piezoelectric sounding body in the mass part 14A so as to house the piezoelectric sounding body 20 and the cushioning material 16 there.

The example shown in FIG. 10A makes use of a plate frame 60 having a circular projection at the end thereof. The plate frame may be made of ABS or acrylic. The circular projection of the plate frame 60 has an opening 62 for receiving and supporting the diaphragm 22 having the piezoelectric element 24 (or the piezoelectric elements 24 and 26). Then, the plate frame 60 is closely adhered and secured on the upper face of the mass part 14 via an adhesive material such as double-coated tape, and the partition 18 is installed as in the above mentioned embodiment for defining the main air-chamber. By closely adhering the plate frame 60 to the mass part 14, the mass and the thickness of the mass part 14 substantially increase, so that a further improvement may be expected in restraining vibration of the casing, or flattening the sound pressure characteristic. It is also sufficient to provide a difference 64 in level in the inside of the opening 62 so as to support the diaphragm 22 by this difference 64 in level. This embodiment may be assumed as extending the case 27 of the above mentioned piezoelectric sounding body 20 to be plate shape.

The example shown in FIG. 10B uses a printed wiring substrate 70 of such as a glass epoxy as the plate frame 60 of FIG. 10A. The printed wiring substrate 70 is mounted on one side with electronic parts 72 as a resistor, capacitor, coil, or semi-conductor, with which various kinds of electronic circuits are formed as the piezoelectric sounding body driving circuits such as a boosting circuit or an amplifying circuit. On the other side of the printed wiring substrate 70, the electronic parts 74 are mounted. The opening 62 is formed at an end of the printed wiring substrate 70. The present embodiment secures the printed wiring substrate 70 to the mass part 14, such that the end part provided with the electronic parts of the printed wiring substrate 70 projects beyond the edge of the mass part 14, that is, the position shown with a dotted line is in line with the end of the mass part 14. According to this embodiment, the substantial mass and thickness of the mass part 14 increase by mounting the electronic parts 72, 74, and the further improvement may be expected.

The example shown in FIG. 10C provides a conductive electrode 82 in a thin printed wiring substrate 80 as a flexible substrate and directly adheres the piezoelectric element 24. In the present embodiment, the printed wiring substrate 80 works as the diaphragm. Such a printed wiring substrate 80 is closely fixed to the upper face of the mass part 14, interposing a spacer 84 formed by an elastic substance in the piezoelectric element 24. Further, the partition plate 18 is provided for defining the main air-chamber. Also in this embodiment, the printed wiring substrate 80 is secured to the mass part 14 such that the position shown with the dotted line is in line with the end of the mass part 14. According to this example, since the printed wiring substrate 80 is thin, the improvement is not so much effected as the above embodiment as to the thickness of the mass part 14, but the structure of the piezoelectric sounding body is simplified and formed as one of the electronic parts on the flexible substrate, and an advantage is brought about as simplifying the mounting.

The present invention includes many embodiments, and various modifications are available on the basis of the above mentioned disclosure. For example, the followings may be included. P 1) The materials, shapes or dimensions shown in the above embodiments are only examples, and designs may be modified to exhibit similar characteristics. The structure of the piezoelectric sounding body may be either of unimorph and bimorph. The acoustic element itself has a structure alternately laminated with a piezoelectric layer and an electrode layer, and the number of laminated layers, the connecting pattern of the internal electrode, or the drawer structure may be appropriately changed as needed.

2) As the casing, so far as being structured for securing, protecting or sealing parts within the electronic instrument, it is not necessarily outermost. The mass part is typically thicker and heavier than the casing, and is often formed on an extension of the casing. The resonance frequency is in proportion with thickness, and also from this viewpoint, the mass part is usually thickest. The mass part has the suitable examples in the liquid crystal display, battery, or part mounting printed circuit substrate. Further, the spaces for installing the piezoelectric sounding body are assumed between the display means and the protective cover, a stroke space under a key board, or between the wall of a battery chamber and battery case.

3) The piezoelectric sounding body may be attached to the mass part by adhesive or pressure. The cushioning material or the spacer may be provided. The electronic parts are present in the main air-chamber or the sub air-chamber. The sub air-chamber may be one part of plural spaces in the casing partitioned by the partition wall.

4) The above mentioned embodiments may be combined, for example, as combining the embodiments of FIGS. 9A, B, C, E, F and of FIG. 10A to C and the embodiment of FIG. 9D.

5) As preferably applied examples of the invention, there are many kinds of electronic instruments such as the portable telephone, portable information terminals (PDA), voiceless coder, or PC (personal computer).

As above explained, according to the invention, it is possible to restrain vibration of the casing, efficiently drive the piezoelectric sounding body itself, and flatten the sound pressure characteristic within the electronic instrument requiring the miniaturized type, light weight, and thin type in the electronic instrument, in particular the portable telephone.

As many apparently widely different embodiments of this invention may be made without departing from the spirit and scope thereof, it is to be understood that the invention is not limited to the specific embodiments thereof except as defined in the appended claims.

1. An electronic instrument, comprising
a casing,
a piezoelectric sounding body supported in said casing,
a mass part supported in said casing, and having thickness in total thicker than the thickness of a wall of said casing, and
wherein said piezoelectric sounding body is secured to said mass part.

2. An electronic instrument as set forth in claim 1, wherein said mass part has a resonance frequency, and said resonance frequency is a frequency outside of a human audio-frequency range.

3. An electronic instrument as set forth in claim 1, wherein said mass part and said piezoelectric sounding body overlap by 30% or more.

4. An electronic instrument as set forth in claim 1, wherein said piezoelectric sounding body is attached to said mass part with adhesive or pressure.

5. An electronic instrument as set forth in claim 1, wherein a main air-chamber of said piezoelectric sounding body is formed to the side of the casing attached with said mass part.

6. An electronic instrument as set forth in claim 1, wherein a main air-chamber of said piezoelectric sounding body has sound issuing holes in the inside and outside of said casing.

7. An electronic instrument as set forth in claim 1, wherein a sub air-chamber of said piezoelectric sounding body is formed within the casing of said electronic instrument.

8. An electronic instrument as set forth in claim 7, wherein said sub air-chamber is one part of plural spaces in the casing partitioned by a partition wall.

9. An electronic instrument as set forth in claim 1, wherein said piezoelectric sounding body is secured to said mass part via a cushioning material.

10. An electronic instrument, comprising
a casing,
a piezoelectric sounding body supported in said casing,
a mass part supported in said casing, and having a resonance frequency outside of a human audio-frequency range, and
wherein said piezoelectric sounding body is secured to said mass part.

11. An electronic instrument, comprising
a casing,
a piezoelectric speaker supported in said casing,
a mass part supported in said casing, and having a resonance frequency outside of a human audio-frequency range, and
wherein said piezoelectric type speaker is attached to said mass part such that said piezoelectric speaker partially overlaps with said mass part.

12. An electronic instrument as set forth in claim 11, wherein said mass part and said piezoelectric sounding body overlap by 30% or more.

13. An electronic instrument as set forth in claim 11, wherein said piezoelectric speaker is attached to said mass part with adhesive or pressure.

14. An electronic instrument as set forth in claim 11, wherein a main air-chamber of said piezoelectric speaker is formed to the side of the casing attached with said mass part.

15. An electronic instrument as set forth in claim 11, wherein a main air-chamber of said piezoelectric speaker has sound issuing holes in the inside and outside of said casing.

16. An electronic instrument as set forth in claim 11, wherein a sub air-chamber of said piezoelectric type speaker is formed within the casing of said electronic instrument.

17. An electronic instrument as set forth in claim 16, wherein said sub air-chamber is one part of plural spaces in the casing partitioned by a partition wall.

18. An electronic instrument as set forth in claim 11, wherein said piezoelectric speaker is secured to said mass part via a cushioning material.

19. An electronic instrument as set forth in claim 11, wherein the piezoelectric speaker has a flat frequency-sound pressure characteristic in the frequency band of 1 to 3 KHz, and is used in a free sound field.

20. An assembly for use in an electronic instrument, said assembly comprising:
an electronic component having mass and dimensions such that a resonant vibration frequency of said first electronic component is outside a normal range of human hearing; and
a piezoelectric speaker attached to said first electronic component such that a portion of said piezoelectric speaker extends beyond an edge of said electronic component.

21. The assembly of claim 20, wherein said electronic component comprises one or more of a display, a battery, a printed circuit board, or a combination thereof.

22. An electronic instrument comprising the assembly of claim 20.

23. A method of making an electronic instrument, said method comprising:
selecting a component of said electronic instrument having desirable audio frequency vibration characteristics; and
attaching a piezoelectric speaker to said component so as to take advantage of said desirable audio frequency vibration characteristics to improve sound quality produced by said electronic instrument.
